(19) United States
(12) Patent Application Publication
(10) Pub. No.: US 2006/0083887 A1
(43) Pub. Date: Apr. 20, 2006

(54) Reduced suffocation-risk films

(76) Inventor: Eric K. Satermo, Irvine, CA (US)

Correspondence Address: Eric K. Satermo, P.O. Box 19099, Irvine, CA, 92623-9099, US

(21) Appl. No.: 10/967,806

(22) Filed: Oct. 18, 2004

(51) Int. Cl. G09F 3/00

(52) U.S. Cl. 428/43; 428/131

(57) ABSTRACT

Reduced suffocation-risk films include discontinuities that enable air to pass through the film in the event that the film is covering an infant's air passages. The film may be used in any number of industries, including the clothing industry, such as film for use by dry cleaners to protect clothes. A film may include a plurality of discontinuities that enable the passage of air through the film. For example, the discontinuities may include apertures, cuts, flaps, slits, and so on. The discontinuities allow the passage of air in the presence of negative pressure, for example, as created by the inhalation of an infant or small child. Accordingly, if an infant's air passages were to be covered with the film, the discontinuities would allow air to pass through the film, thereby sustaining the infant until help arrived. In other embodiments, a sleeve of film may include a plurality of primary weakening lines dividing the sleeve into a plurality of per-use sections. Each of the per-use sections may include a hanger portion and a body portion with a secondary weakening line therebetween. Accordingly, the body portion may be removed from the hanger portion when a garment is taken home and hung in a closet.

### BACKGROUND OF THE INVENTION

The present invention relates to films such as films used in dry cleaning operations and, more particularly, to films which reduce or eliminate the risk of suffocation, particularly the risk of suffocation for infants, toddlers, and young children.

Conventional films and sheet material are used in dry-cleaning applications and for manufacturing grocery bags, garment bags, and other related items. Because of the inherent uniform solidity of conventional films, there is a suffocation risk. For example, according to an article by Drago and Dannenberg entitled “Infant Mechanical Suffocation Deaths in the United States, 1980-1997” (Pediatrics, Vol. 103, No. 5, May 1999), there were 208 deaths caused by oronasal obstruction by plastic bags and 13 deaths caused by entanglement with plastic bags.

According to this same article, “[t]he inherent dangers of plastic film are (1) that it adheres, partially by the act of inhaling and partially by static electricity generated by the movement of the plastic film itself; and (2) it is strong, thus, infants cannot tear it.” The study conducted by Drago and Dannenberg shoed that plastic bags continue to be involved with a substantial number of infant suffocations, on aver one per month during the years of the study.

Accordingly, there is a need in the art for plastic film that reduces the risk of suffocation by infants and small children.

### BRIEF SUMMARY OF THE INVENTION

According to one aspect of the invention, a reduced suffocation-risk film includes discontinuities that enable air to pass through the film in the event that the film is covering an infant's air passages. The film may be used in any number of industries, including the clothing industry, such as film for use by dry cleaners to protect clothes.

In a number of embodiments, a film includes a plurality of discontinuities that enable the passage of air through the film. For example, the plurality of discontinuities may include apertures, cuts, flaps, slits, and so on. In some of the embodiments, such as when the discontinuities includes slits, cuts, or flaps, the discontinuities allow the passage of air in the presence of negative pressure, for example, as created by the inhalation of an infant or small child. Accordingly, if an infant's air passages were to be covered with the film, the discontinuities would allow air to pass through the film, thereby sustaining the infant until help arrived.

In other embodiments, a sleeve of film may include a plurality of primary weakening lines dividing the sleeve into a plurality of per-use sections. Each of the per-use sections may include a hanger portion and a body portion with a secondary weakening line therebetween. Accordingly, the body portion may be removed from the hanger portion when a garment is taken home and hung in a closet. This has the advantage that all film is out of reach of an infant or small child.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 a perspective view of a roll of suffocation-reduced film;

FIG. 2 illustrates suffocation-reduced film in use protecting a garment;

FIG. 3 is an enlarged plan view of a section of suffocation-reduced film as represented by line E in FIG. 2, illustrating a number of embodiments of aperture discontinuities formed in the film;

FIG. 4 is an enlarged plan view of a section of suffocation-reduced film as represented by line E in FIG. 2, illustrating other embodiments of aperture discontinuities formed in the film;

FIG. 5 is a cross-sectional view taken along line 5-5 of FIG. 3;

FIG. 6 is a cross-sectional view taken along line 6-6 of FIG. 3;

FIG. 7 is an enlarged plan view of a section of suffocation-reduced film as represented by line E in FIG. 2, illustrating a number of embodiments of cut discontinuities formed in the film;

FIG. 8 is an enlarged plan view of a section of suffocation-reduced film as represented by line E in FIG. 2, illustrating other embodiments of cut discontinuities formed in the film;

FIG. 9 is an enlarged plan view of a section of suffocation-reduced film as represented by line E in FIG. 2, illustrating still other embodiments of cut discontinuities formed in the film;

FIG. 10 is an enlarged plan view of a section of suffocation-reduced film as represented by line E in FIG. 2, illustrating a number of embodiments of flap discontinuities formed in the film;

FIG. 11 illustrates air passages and negative pressure caused by inhalation in an infant or small child;

FIG. 12A is an enlarged plan view of film with cut discontinuities, illustrating the film when not subject to negative pressure;

FIG. 12B is view similar to FIG. 12A, illustrating the film when subject to negative pressure;

FIG. 12C is a cross-sectional view taken along line 12C-12C of FIG. 12B;

FIG. 13A is an enlarged plan view of film with cross discontinuities, illustrating the film when not subject to negative pressure;

FIG. 13B is view similar to FIG. 13A, illustrating the film when subject to negative pressure;

FIG. 13C is a cross-sectional view taken along line 13C-13C of FIG. 13B;

FIG. 14A is an enlarged plan view of film with flap discontinuities, illustrating the film when not subject to negative pressure;

FIG. 14B is view similar to FIG. 14A, illustrating the film when subject to negative pressure;

FIG. 14C is a cross-sectional view taken along line 14C-14C of FIG. 14B;

FIG. 15 is a fragmentary plan view of a film sleeve according to a number of embodiments with per-use sections;

FIG. 16 illustrates a per-use section with a hanger portion and a body portion in use over a garment;

FIG. 17 illustrates the per-use section of FIG. 16 with the body portion removed;

FIG. 18 is a fragmentary plan view illustrating other embodiments of a film sleeve;

FIG. 19 illustrates a per-use section of the film sleeve of FIG. 18 in use on a garment;

FIG. 20 is a fragmentary plan view of other embodiments of a sleeve of film;

FIG. 21 is an enlarged plan view of a section of the film of FIG. 20; and

FIG. 22 is a fragmentary plan view of reduced suffocation-risk film in which the discontinuities are represented with cross hatching.

### DETAILED DESCRIPTION OF THE INVENTION

A number of embodiments of films and of rolls of film that present a reduced suffocation risk to infants and small children as shown in the drawings. Films associated with clothing industries, such as laundry and dry cleaning and retail sales, are particularly illustrated. However, the principles of the invention are applicable to films used in other industries, such as plastic shopping bags, wraps used for palletizing cartons, and so on.

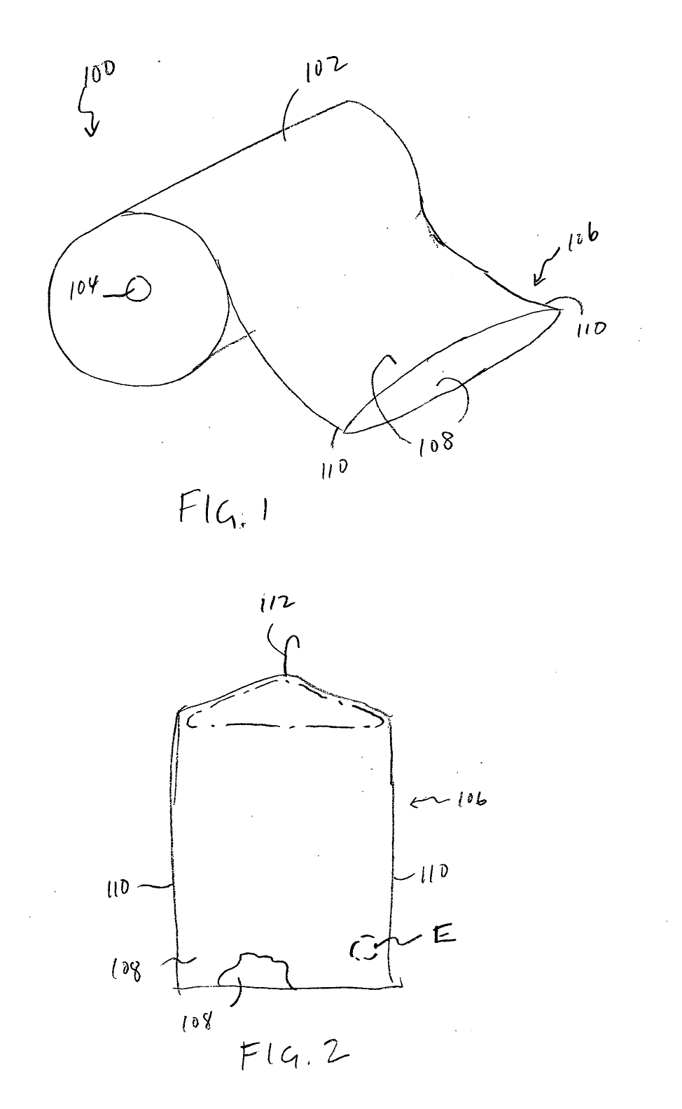

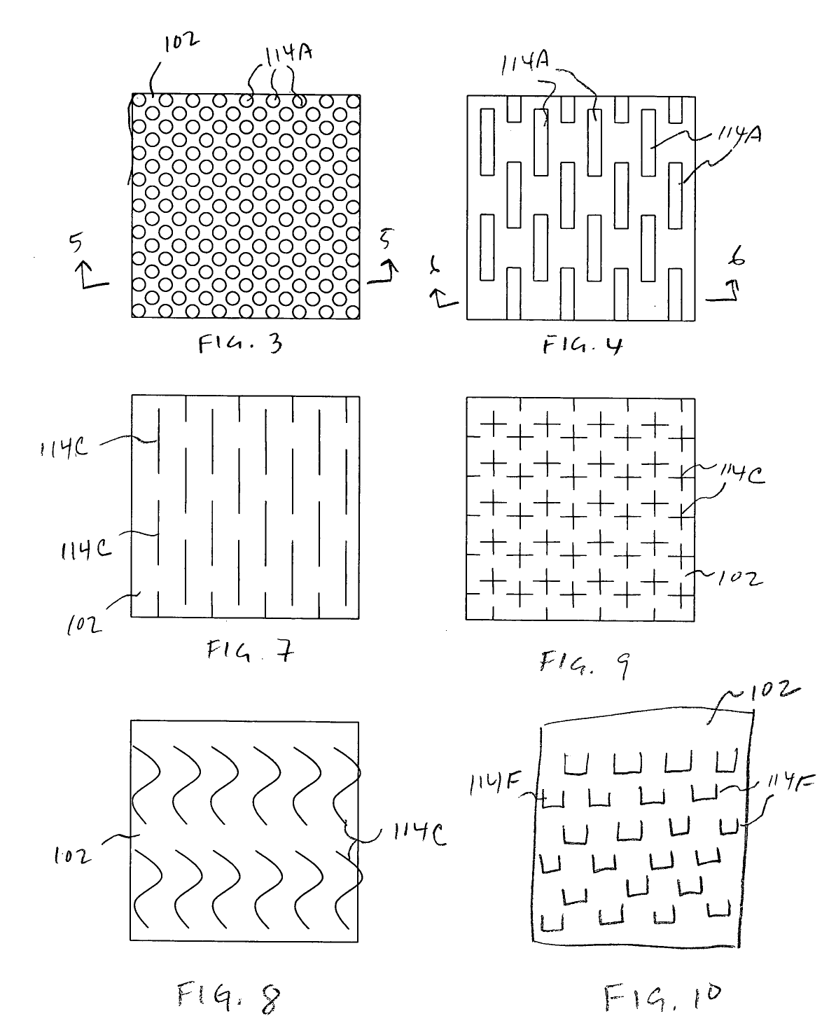

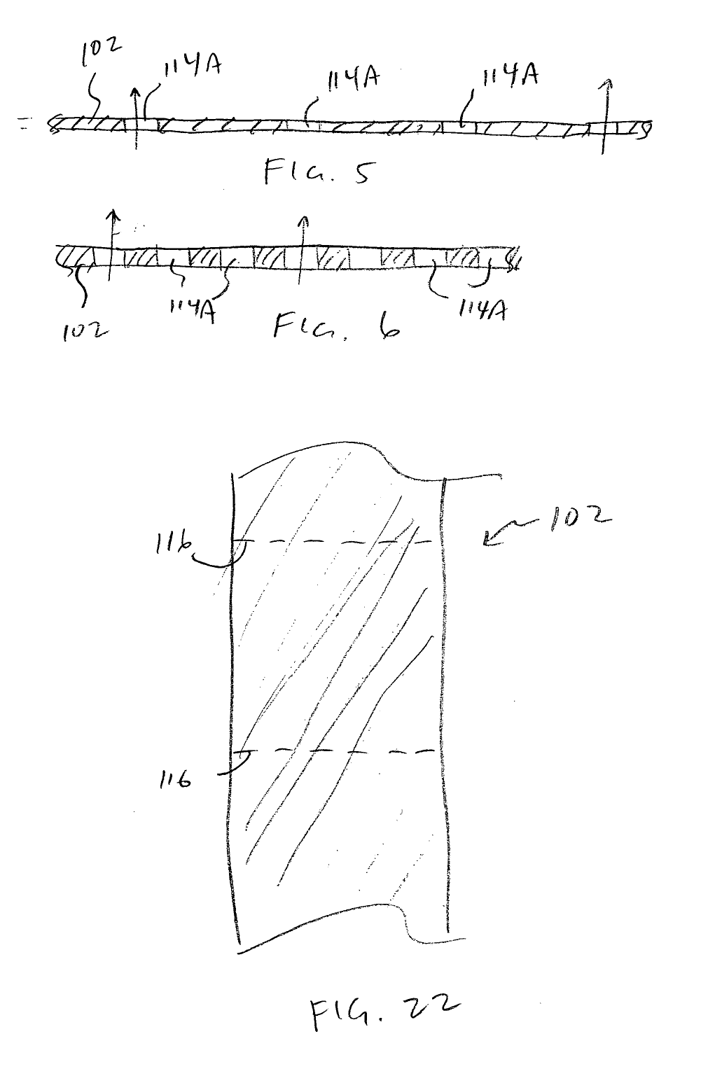

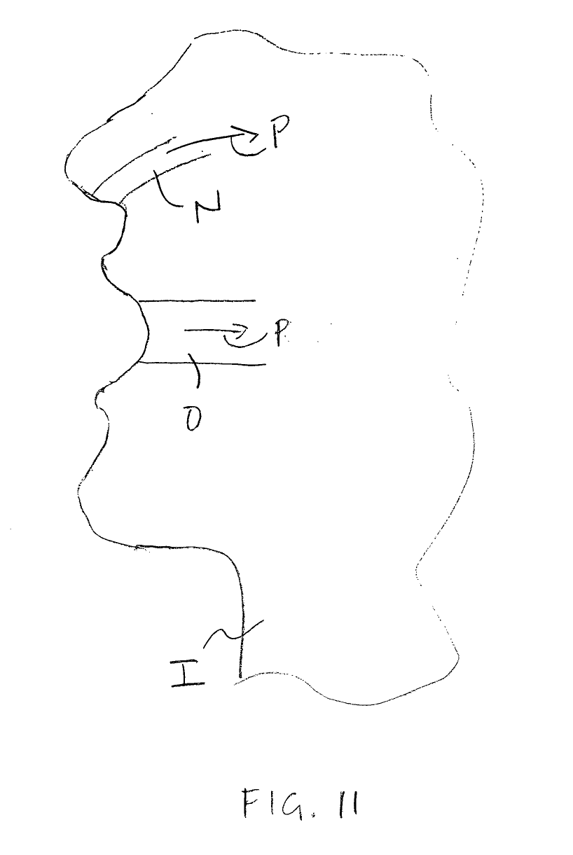

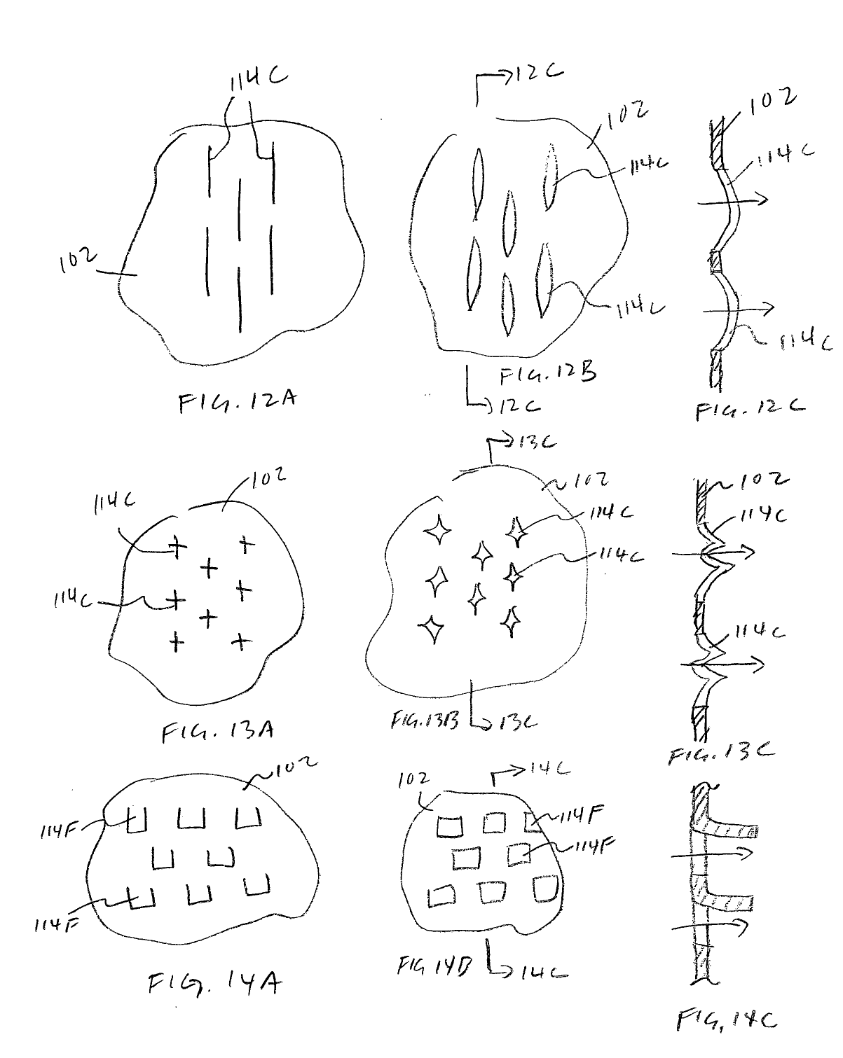

Referring to FIG. 1, a roll 100 of clothing film includes a film 102 wound upon a central core 104. In a number of embodiments, the film 102 may be in the form of a sleeve 106. In some of the embodiments, the sleeve 106 may have a pair of sheets 108 with a pair of opposing side edges 110. Describing the sleeve embodiments is particularly applicable in commercial embodiments, such as shown in FIG. 2 when utilized to protect an article of clothing (not shown) hung on a hanger 112. However, those skilled in the art will understand that when disposed in roll form on a central core, the film sleeve may be folded in any number of configures as desired.

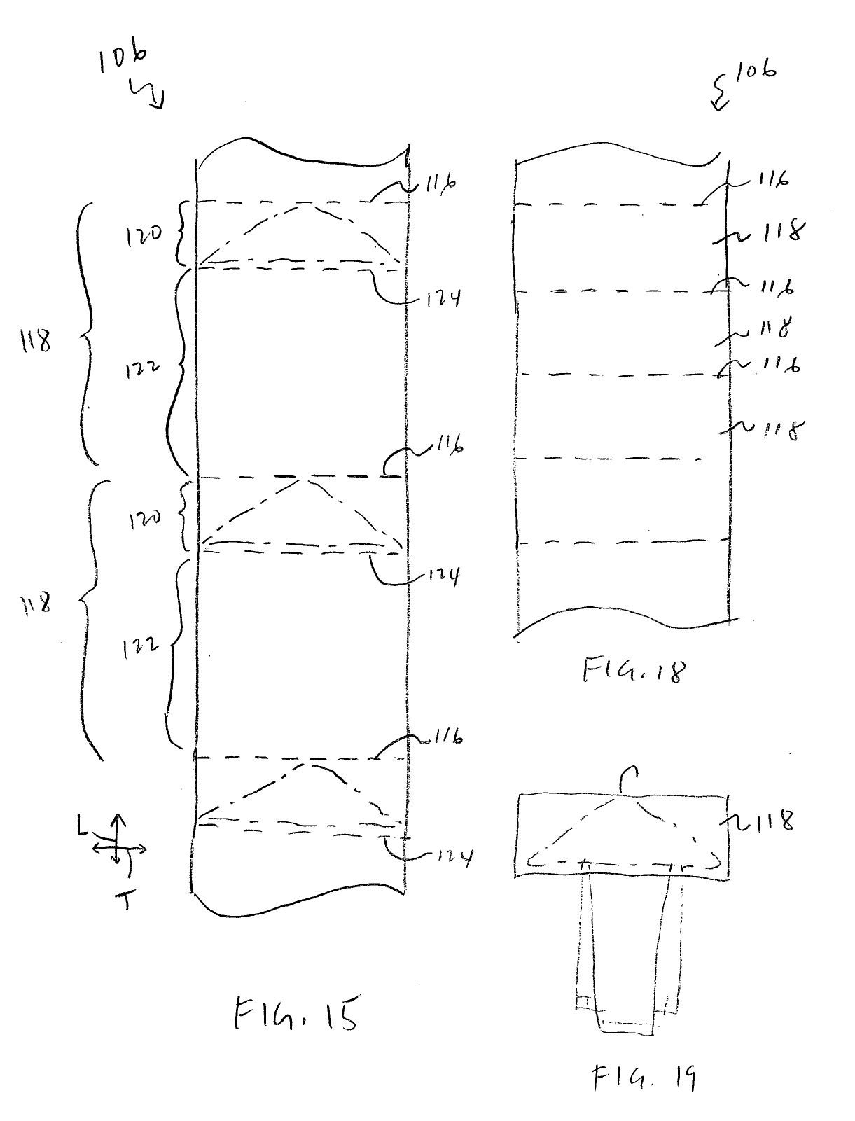

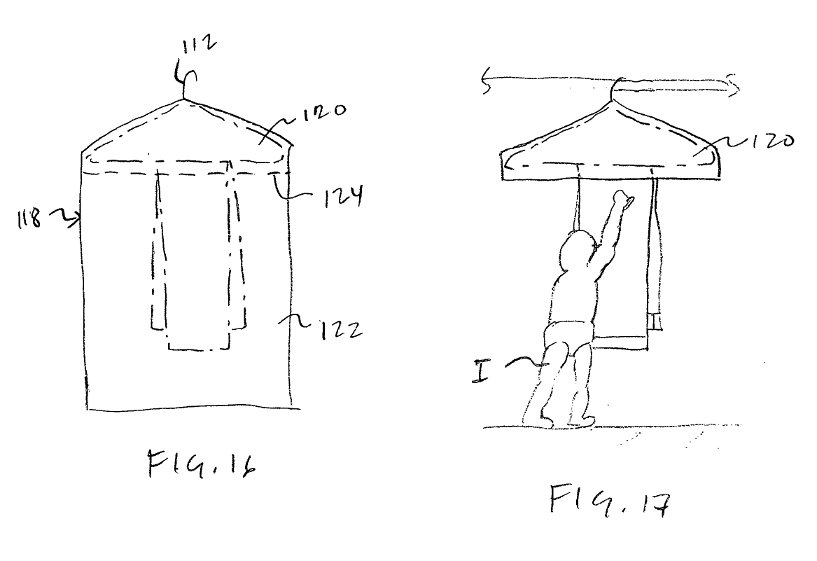

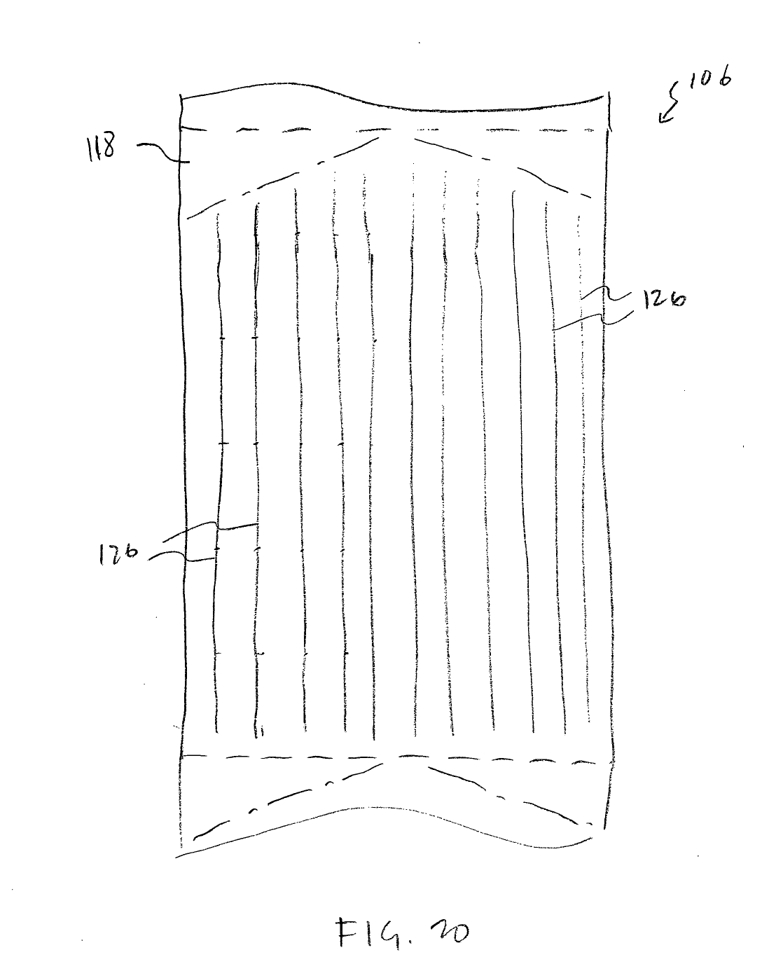

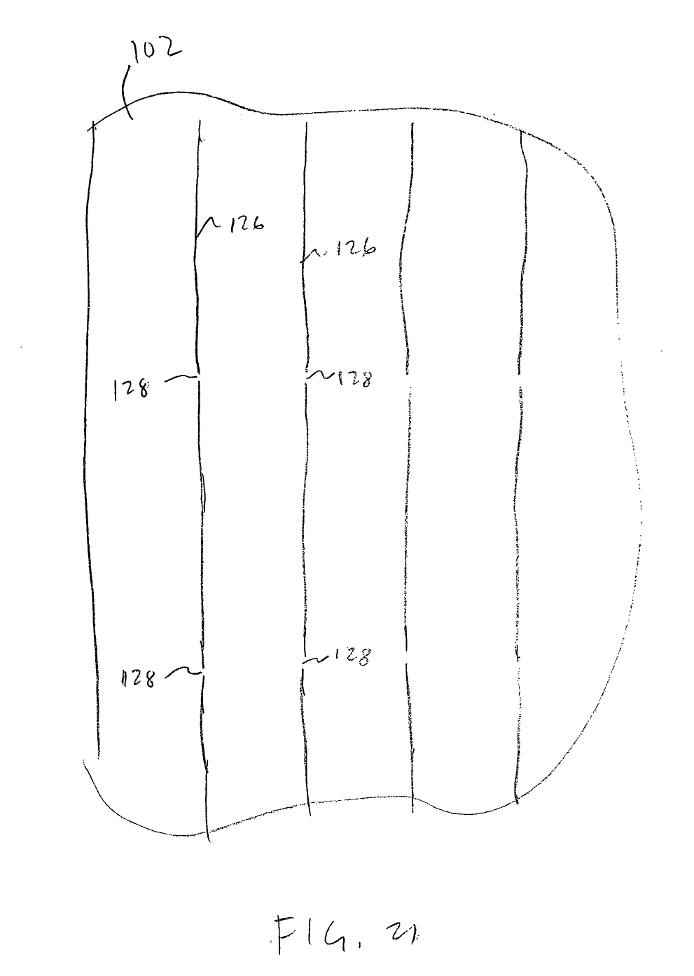

According to a number of embodiments, at least a portion of the film 102 includes a plurality of discontinuities or film breaks for enabling passage of air through the film 102. For example, as shown in FIGS. 3 and 4, the film 102 may include a plurality of discontinuities 114 that are in the form of apertures, for example, curvilinear apertures 114A as shown in FIG. 3 or rectilinear apertures 114A as shown in FIG. 4, with the apertures 114A formed through the film 102 as shown in FIGS. 5 and 6, respectively. In some of the embodiments, the apertures 114A may be disposed in a high-density pattern, as particularly shown in FIG. 3. In other embodiments, the apertures 114A may be spaced apart but elongated, as particularly shown in FIG. 4.

In alternative embodiments, the film 102 may include a plurality of discontinuities 114 that are in the form of cuts. In a number of embodiments, each of the discontinuities 114 may be a single cut, for example, a linear cut 114C as shown in FIG. 7 or a curvilinear cut 114C as shown in FIG. 8. In other embodiments, each of the discontinuities 114 may include a plurality of cuts, for example, a pair of cuts in the form of a cross 114C as shown in FIG. 9.

In still other embodiments, the film 102 may include a plurality of discontinuities 114 that are in the form of flaps 114F as shown in FIG. 10. The flap 114F may be curvilinear (not shown) or may be formed by three linear cuts as shown.

For the purposes of this description, the discontinuities will be generally referenced with numeral 114 without the alpha suffix, while the aperture, cut, and flap discontinuities will be specifically referenced with numeral 114 with the specifying alpha suffix A, C, and F, respectively. In addition, the term discontinuity is used herein to describe any type of element or structure formed on or in the film 102 that enables the passage of air either without the presence of negative pressure (as described below) or in the presence of negative pressure.

Regardless of the particular embodiments, each of the discontinuities 114 may enable the passage of air therethrough. For example, in the aperture embodiments, air is able to pass through the discontinuities 114A as shown by the arrows in FIGS. 5 and 6. In the cut and flap embodiments, the discontinuities 114C and 114F may be configured to open under negative pressure.

More specifically, referencing FIG. 11, an infant or small child I is represented to have a nasal air passage N and an oral air passage O. When an infant I inhales, the vacuum or inflow of air causes negative air pressure indicated by arrows P to be present at the orifices of the nasal and oral air passages N and O. Accordingly, for the purposes of this description, negative pressure may be defined as being caused by the inhalation of an infant or a small child.

In applying this definition to the discontinuities 114, with reference is made to FIGS. 12A, 12B, and 12C. In FIG. 12A, examples of cuts 114C are shown as closed when not acted upon by negative pressure. However, when the film 102 is at or near an orifice of an air passage, that is, in the presence of negative pressure, the force from the flow of air causes the edges of the cuts 114C to be drawn inward, thereby spreading the cut apart or opening the cut, as shown in FIG. 12B. Accordingly, air is able to pass through the open cuts 114C as shown by the arrows in FIG. 12C.

Similarly, examples of cross cuts 114C are shown as closed when not acted upon by negative pressure in FIG. 13A. However, when the film 102 is subject to negative pressure, force from the flow of air draws the edges of the cross cuts 114C inward, thereby opening the cuts, as shown in FIG. 13B, with air being able to pass through the open cross cuts 114C as shown by the arrows in FIG. 13C. Further, examples of flaps 114F are shown as closed when not acted upon by negative pressure in FIG. 14A. However, when the film 102 is subject to negative pressure, force from the flow of air draws the flap 114F inward, thereby creating an opening, as shown in FIG. 14B, with air being able to pass through the open flap 114C as shown by the arrows in FIG. 14C. Accordingly, the cut and flap discontinuities 114C and 114F may open and enable air passage at a level of negative pressure exerted by the lungs of an infant through the mouth or the nose.

In view of the air-passable property of the discontinuities 114, if an infant or child where to become entangled in the film 102, the infant would be able to draw air through the discontinuities 114 and continue breathing. Accordingly, the air passage through the discontinuities 114 may be able to sustain an entangled infant until rescued by a guardian. In addition to allowing air passages, the discontinuities 114 weaken the strength of the film 102, thereby making it easier for an infant to tear the film 102.

With reference to FIG. 15, in a number of embodiments, the sleeve 106 of clothing film may include a plurality of primary weakening lines 116 dividing the sleeve 106 into a plurality of per-use sections 118. Each of the per-use sections 118 may include a hanger portion 120 and a body portion 122. A plurality of secondary weakening lines 124 may be formed in the sleeve 106 in each of the per-use sections 118 to divide the hanger portion 120 from the body portion 122. The phantom line is used in the drawings to indicate where a hanger is to be received.

When in commercial use, a trailing or end per-use section 118 may be removed along a primary weakening line 116 from the sleeve 106 and disposed over an article of clothing as shown in FIG. 16. When the article of clothing returned home and hung in a closet as shown in FIG. 17, the body portion 122 may be removed from the hanger portion 120 along the secondary weakening line 124. Accordingly, there is no film within the reach of an infant I or small child. In addition, in many instanced, even the hanger portion 120 may be out of reach of the infant.

While in a number of embodiments in which the per-use sections 118 include a removable body portion 122, the film 102 may include a plurality of discontinuities 114 formed in the body portion 122, in other embodiments the film 102 does not include a plurality of discontinuities. In these latter embodiments, the suffocation risk is reduced by the removal of the body portion 122 when the garment is stored in a closet. The roll of laundry film of claim 15 each of the body portions includes a plurality of discontinuities each configured to enable air to pass therethrough at negative pressure.

In a number of embodiments, the hanger portion 120 may range in a longitudinal dimension (with longitudinal and transverse being indicated by arrows L and T, respectively, in FIG. 15) from a few inches to a few feet. For example, the hanger portion 120 may have a longitudinal dimension that extends just over the top of a garment hung on a hanger. In other embodiments, the hanger portion 120 may extend about half-way down the length of the garment. In still other embodiments, the hanger portion 120 may have a longitudinal dimension of less than about 2 feet or so.

In still other embodiments as shown in FIG. 18, the sleeve 106 of clothing film may include a plurality of primary weakening lines 116 dividing the sleeve 106 into a plurality of per-use sections 118. Each of the per-use sections 118 may have a longitudinal dimension analogous to the hanger portion 120 described above. Accordingly, in use, the trailing or end per-use section 118 may be removed along a primary weakening line 116 from the sleeve 106 and disposed over an article of clothing as shown in FIG. 96. When the article of clothing returned home and hung in a closet, the per-use section 118 may be out of the reach of an infant or small child.

In other embodiments as shown in FIG. 20, the film 102 may include a plurality of discontinuities in the form of elongated slits 126. In a number of embodiments, the elongated slits 126 may be disposed longitudinally along each of the per-use sections 118 of the sleeve 106. In other embodiments, the slits 126 may be disposed only along the body portion. As shown in FIG. 21, in some of the embodiments, each slit 126 may include one or more breakable ties 128 that hold opposing edges of the slit 126 together. Accordingly, if an infant were to become entangled with the film 102, the slits 126 would split apart and provide the infant an opportunity to breathe and even escape. In addition, the slits 126 allow an infant to tear the film 102 away if entangled.

For clarity in the drawings, the discontinuities 114 are not shown in figures highlighting embodiments of, for example, the film sleeve 106 (see, e.g., FIGS. 1 and 2), but are rather shown in the enlarged views (see, e.g., FIGS. 3-10). However, to illustrate the discontinuities 114 in relation to the film 102, the discontinuities 114 are represented by cross hatching in FIG. 22. In the embodiment shown, the discontinuities 114 may be formed in substantially the entire extent of the film 102, as underscored by the representation of the weakening lines 116. In other embodiments, the discontinuities 114 may be limited to the body portion 122 (see, e.g., FIG. 15) of the sleeve 106.

To produce the film 102, a manufacturer may first fabricate or provide a solid or continuous film as known in the art. The film may then be passed through a device that is able to form the discontinuities, such as by cutting, slicing, or melting. Those skilled in the art of film manufacture will appreciate that the discontinuities 114 may be formed in the film 102 at any step of the manufacturing process, e.g., at the time the weakening lines 116 are formed.

In a commercial business such as a dry cleaners, customers may be offered child-safety films for their clothing, rather than conventional films. By providing their customers with children with such a choice, proprietors are able to generate goodwill from their customers by possible avoiding an incident of a child becoming entangled with solid film.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

What is claimed is:

1. A reduced suffocation-risk film comprising:
a plurality of discontinuities for enabling passage of air through the film.

2. The film of claim 1 wherein the plurality of discontinuities includes apertures.

3. The film of claim 1 wherein the plurality of discontinuities includes cuts.

4. The film of claim 1 wherein the plurality of discontinuities includes flaps.

5. The film of claim 1 wherein the plurality of discontinuities includes cuts that are configured to open under negative pressure.

6. The film of claim 5 wherein the cuts open at a level of negative pressure exerted by the lungs of an infant through the mouth.

7. The film of claim 1 wherein the plurality of discontinuities includes a plurality of elongated slits.

8. The film of claim 5 wherein each of the slits is longitudinally disposed and includes at least one tie to hold together opposing edges of the slit.

9. A roll of clothing film comprising a film sleeve having a plurality of discontinuities formed therein each configured to enable passage of air therethrough.

10. The roll of laundry film of claim of claim 9 wherein the discontinuities allow air to pass therethrough under negative pressure.

11. The roll of laundry film of claim 9 wherein the film sleeve includes a plurality of per-use sections.

12. The roll of laundry film of claim 11 wherein the film sleeve includes a plurality of weakening lines that separates the per-use sections from each other.

13. The roll of laundry film of claim 9 wherein each of the per-use sections includes a hanger portion and a body portion.

14. The roll of laundry film of claim 13 wherein each of the per-use section includes a weakening line between the hanger portion and the body portion such that the body portion may be separated from the hanger portion.

15. A roll of clothing film comprising a film sleeve including a plurality of primary weakening lines dividing a plurality of per-use sections;
each of the per-use sections including a hanger portion and a body portion with a secondary weakening line therebetween such that the body portion is separable from the hanger portion along the secondary weakening line.

16. The roll of laundry film of claim 15 each of the body portions includes a plurality of discontinuities each configured to enable air to pass therethrough at negative pressure.

17. The roll of laundry film of claim 15 wherein the hanger portion has less than about a 2-foot longitudinal dimension.

18. A method of manufacturing clothing film, the method comprising:
providing a film; and
forming a plurality of discontinuities in the film, each of the discontinuities being configured to allow air to pass therethrough at negative pressure.

19. The method of claim 18 wherein the forming step includes:
forming a plurality of apertures in the film.

20. The method of claim 18 wherein the forming step includes:
forming a plurality of cuts through the film.
